(19) United States
(12) Patent Application Publication
(10) Pub. No.: US 2020/0019971 A1
(43) Pub. Date: Jan. 16, 2020

(54) SHARING INFORMATION ABOUT ENTERPRISE COMPUTERS

(71) Applicant: International Business Machines Corporation, Armonk, NY (US)

(72) Inventors: Ali Y. Duale, Poughkeepsie, NY (US); Maharaj Mukherjee, Poughkeepsie, NY (US); Richard B. Finch, New Paltz, NY (US); Oswald J. Mantilla, Dutchess, NY (US); Syed F. Hossain, Wappingers Falls, NY (US); Jacob Porter, Highland, NY (US); Bohdan Demczar, Hyde Park, NY (US)

(21) Appl. No.: 16/033,337

(22) Filed: Jul. 12, 2018

(51) Int. Cl. G06Q 30/00

(52) U.S. Cl. CPC G06Q 30/016

(57) ABSTRACT

Aspects of the invention include receiving system status information about a plurality of computer systems from a plurality of customers. The system status information includes a plurality of types of system status information and each of the plurality of customers provides at least a subset of the plurality of types of system status information. Customer identifiers are removed from the received system status information. For each of the customers it is determined whether a type of the plurality of types of system status information was received from the customer. Based at least in part on determining that the type of system status information was received from the customer, a trend in the type of system status information is determined. The trend is based at least in part on system status information received from at least one other of the plurality of customers. The trend is provided to the customer.

### BACKGROUND

Embodiments of the present invention relate in general to computer systems, and more specifically to sharing information about enterprise computers.

Currently, customers who own complex computer systems set up special relationships with the manufacturer of those computer systems. Such relationships may include service and support for the computer systems. Customers rely mainly on information provided by the manufacturers as well as publicly shared studies for determining how to configure their computer systems. Rarely is there any direct communication exchanged with other customers having similar computer systems. This can be due to customers not wanting to share information about their internal operations and business practices with the other parties or with the public.

Accordingly, while existing manners of sharing enterprise computer configuration information are suitable for their intended purposes, what is needed are manners of sharing enterprise configuration information having certain features of embodiments of the present invention.

### SUMMARY

Embodiments of the present invention include methods, systems, and computer program products for sharing information about enterprise computers. A non-limiting example method includes receiving system status information about a plurality of computer systems from a plurality of customers. The system status information includes a plurality of types of system status information and each of the plurality of customers provides at least a subset of the plurality of types of system status information. Customer identifiers are removed from the received system status information. For each of the customers it is determined whether a type of the plurality of types of system status information was received from the customer. Based at least in part on determining that the type of system status information was received from the customer, a trend in the type of system status information is determined. The trend is based at least in part on system status information received from at least one other of the plurality of customers. The trend is provided to the customer.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system for sharing computer system information in accordance with one or more embodiments of the present invention;

FIG. 2 is a block diagram of information flow for sharing computer system information in accordance with one or more embodiments of the present invention;

FIG. 3 is a flow diagram of a process for sharing computer system information in accordance with one or more embodiments of the present invention;

FIG. 4 depicts a cloud computing environment according to one or more embodiments of the present invention;

FIG. 5 depicts abstraction model layers according to one or more embodiments of the present invention; and

FIG. 6 is a block diagram of a computer system for implementing some or all aspects of performing cognitive recognition and filtering of cyberbullying messages.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

One or more embodiments of the present invention allow different customers to share their systems' information in a manner that allows each customer to benefit from the shared information without compromising their own private company data. An open system is provided where groups of customers can share their systems' status with other customers without jeopardizing their internal propriety. One or more embodiments of the present invention use a shared information database where each customer contributes to the shared information. In addition, the system can analyze the information from all of the customers in the shared information database. The results of this analysis can be compared to a particular customer's system status information (e.g., hardware and software levels, temperature, workloads). Based on the analysis and comparison, the system can provide one or more recommendations to the customer.

Sharing of information between customers having similar system configurations can help to ensure smooth and optimized installation and operations of customer hardware and software solutions as subscribing customers have access to problems during installation, problems and successes during operation, and general testimonies about performance and creativity with the solution.

In accordance with one or more embodiments of the present invention, computer systems belonging to “n” customers communicate with each other. Each customer can automatically contribute to the shared information and can automatically retrieve information provided by others. Types of system status information that can be provided to a shared information database can include, but are not limited to: system configuration; system workload (may include running applications); throughput; system temperature; system updates (including, e.g., microcode level); known failures (including, e.g., causes and remedies); and down time. Each customer can choose the type of information that they want to share with other customers. This can be accomplished by setting rules, similar to the way that a file system sets rules to control access to files in the file system, to indicate that an aspect can be shared with any other customer or only with specific groups (e.g., based on industry, geographic location, configuration) of customers or it can't be shared with any other customers. One or more embodiments of the present invention also provide an incentive to share system status information by allowing a customer to have access to only data in the shared information database that is of the same type as the information shared by the customer. In this manner, permissions are bidirectional such that permissions given by a customer to share a particular type of information with other customers are reciprocated.

In accordance with one or more embodiments of the present invention, without compromising their company secrets and/or confidential information, customers can contribute relevant information that may benefit the rest of the customers that have access to the shared information database. Different customers can customize the use of the shared information and utilize the shared information database in different ways. A customer can, for example, set its monitoring system to focus on workloads, while another customer can focus on monitoring recent updates.

Filters can be set up for each customer based on the system status information that they provide and the type of data that they would like to monitor (e.g., all or a subset of the type(s) of information that they provide). By setting up filters, the data can be collected and monitored automatically by a processor without human intervention. Providing the ability to use filters to focus on a subset of the system status information can lead to a decrease in network or bus traffic between the customer locations and the locations where the shared information database is stored, as well as a decrease in an amount of storage needed to store contents of the shared information database. One or more embodiments of the present invention can be utilized to improve the overall information shared by different customers.

Advantages to customers using one or more embodiments of the present invention include, but are not limited to: being aware of current trends in the usage of computers; being able to perform quick root-cause analysis; sharing expertise and lessons learned which can lead to a robust system utilization; maximizing throughputs; and budget and cost forecasting assistance.

In one or more embodiments of the present invention, the shared information database is maintained by trusted entities such as the manufacturer of the computer systems that are the subject of the shared information. The entity that maintains the shared information database keeps all confidential information (e.g., an identity of a customer) protected.

To encourage sharing of system status information among customers, a customer has to contribute to the pool, or type, of system status information that they want to fetch from the shared information database. For example, if a customer wants to periodically compare the temperature of its computer system to the average temperature of all participating computer systems, then the customer must be a contributor of temperature data.

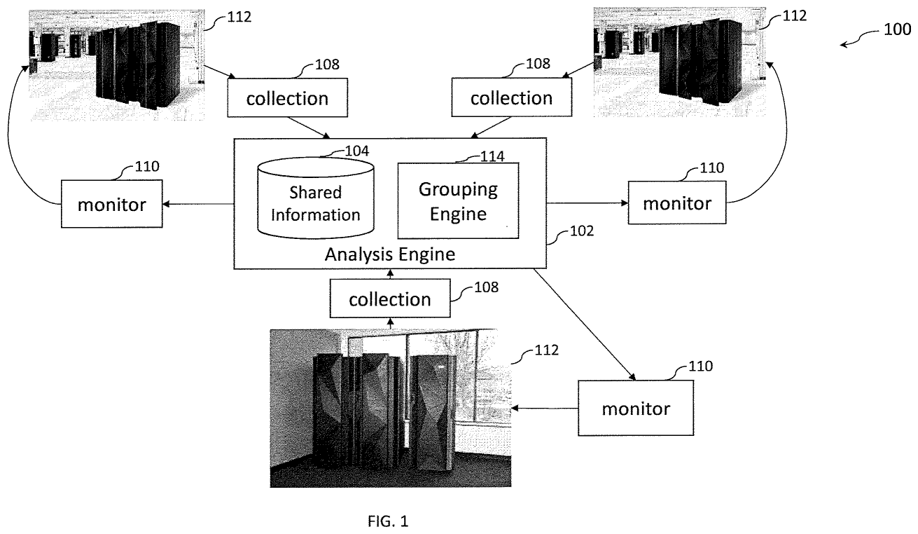

Turning now to FIG. 1, a system 100 for sharing computer system information is generally shown in accordance with one or more embodiments of the present invention. The system 100 in FIG. 1 includes enterprise computers 112 at different customer locations, monitor modules 110, collection modules 108, and an analysis engine 102. In an embodiment of the present invention, the enterprise computers 112 can be implemented by any computer systems known in the art such as, but not limited to Power® systems or z Systems® from IBM. The analysis engine 102 receives system status information from the collection modules 108 and can store the received records in shared information database 104. In an embodiment, before the records are stored in the shared information database 104 anything that can identify a specific customer is removed (e.g., customer name, address, etc.). In an alternate embodiment of the present invention, information that can identify a customer is stored in shared information database 104 but is removed by grouping engine 114.

In one or more embodiments of the present invention, collection modules 108 collect system status information from the enterprise computers 112 and the monitor modules 110 provide data from the shared information database 104 to the enterprise computers 112. As described previously, a collection filter can be set up by a customer to indicate the type(s) of system status information that can be collected from their computer system(s). The collection module 108 uses the collection filter to determine what type(s) of information to collect from the enterprise system(s) 112 belong to the customer. In an embodiment of the present invention, the collection module 108 is given authorization to access the enterprise system 112 to collect specified (e.g., by the collection filter) system status information. In another embodiment of the present invention, the specified system status information is pushed to the collection module 108. In an embodiment, the collection module 108 initiates requests to the enterprise systems when the enterprise is slow in sending the needed information.

Also as described previously, a monitor filter can be set up by a customer to indicate the type(s) of system status information from other customers that they want to monitor. The monitor module 110 uses the monitor filter to determine the type of information that the grouping engine 114 should collect from the shared information database 104 for the customer. The grouping engine 114 analyzes the data to determine trends such as, but not limited to: environmental characteristics (e.g., average temperatures, maximum power usage, etc.), software/hardware versions in use; time between upgrades; workload; and configurations. In an embodiment of the present invention, in order to encourage the sharing of information, the monitor filter when applied to the information in the shared information database 104 results in at least a subset of the information that would result from applying the collection filter.

In one or more embodiments of the present invention, one or both of the collection filter and the monitor filter specify subsets within the types of system status information. For example, a customer may only want to share information related to particular processors, or particular software products (or versions/patch levels). A customer could also specify granular data for particular hardware elements along with more general data for a group of hardware elements. For example, the customer may be interested in the temperature of an enterprise system 112 and also be interested in the temperature of a memory device used in the memory system.

In one or more embodiments of the present invention, the grouping engine 114 uses a monitor filter set up by a customer to determine what records to pull from the shared information database 104 for analysis. The grouping engine 114 can also use the monitor filter to determine trends of interest to the customer. In an embodiment, the grouping module creates, for each user, the set of information that the user is authorized to see. For example, if the user contributes two pools, or types, of the shared information, the grouping module will collect and send to that user only the overall information related to those two pools.

The monitor modules 110 can provide trend information to the enterprise computers 112 on a continuous basis, on a periodic basis and/or in response to updates in the shared information database 104. Each customer can set up a different frequency and/or trigger event for receiving the trend information. Similarly, the collection modules 110 can request or receive system status information from the enterprise computers 112 on a continuous basis, on a periodic basis and/or in response to changes (e.g., software updates, changes in environmental characteristics over a threshold, etc.) at the enterprise computers 112. Each customer can set up a different frequency and/or trigger event for the collection module 108 to request or receive system status information. In one or more embodiments of the present invention, the monitor filter and the collection filter are the same.

The analysis engine 102, collection module 108, and monitor module 110 can be implemented as stand-alone processes on different processors as shown in FIG. 1 or one or more can be implemented on the same processor. For example, the collection module 108 can be executed by a processor of an enterprise system 112 and/or the monitor module 110 can be executed by a processor that executes the analysis engine 102. Similarly, the shared information database 104 and the grouping engine 114 can be in separate physical locations with the grouping engine 114 accessing the shared information database 114 via a network. In addition, the elements shown in FIG. 1 can be coupled to each other directly and/or via one or more wireless or wired networks. Further, the embodiment shown in FIG. 1 shows the monitor module 110 providing the trend information back to the enterprise system 112 that the data collection module 108 collected system status information from; in one or more other embodiments of the present invention, the monitor module 110 provides the trend information to a processor not located in the enterprise system 112.

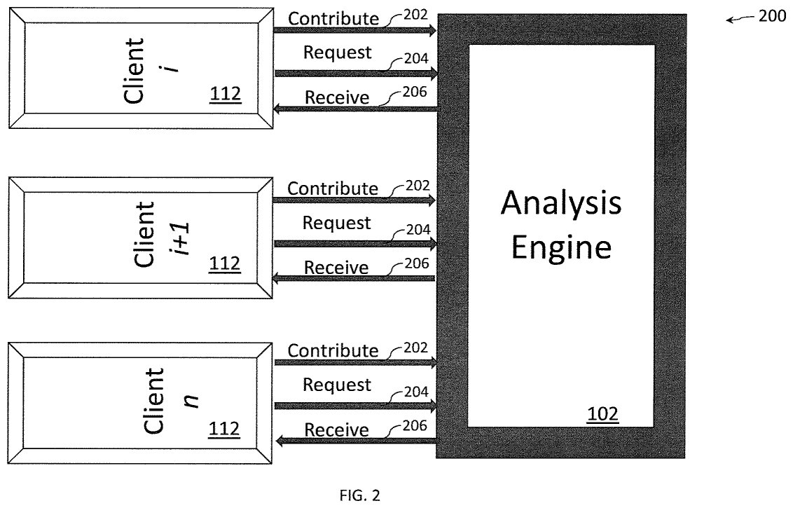

Turning now to FIG. 2, is a block diagram 200 of information flow for sharing computer system information is generally shown in accordance with one or more embodiments of the present invention. The block diagram 200 of FIG. 2 includes “n” clients 112 (also referred to herein as “customers”) and the analysis engine 102 of FIG. 1. As shown in the block diagram 200 of FIG. 2, each client 112 contributes 202 data to the analysis engine 102, requests 204 trend data from the analysis engine 102, and receives 206 trend data from the analysis engine 102.

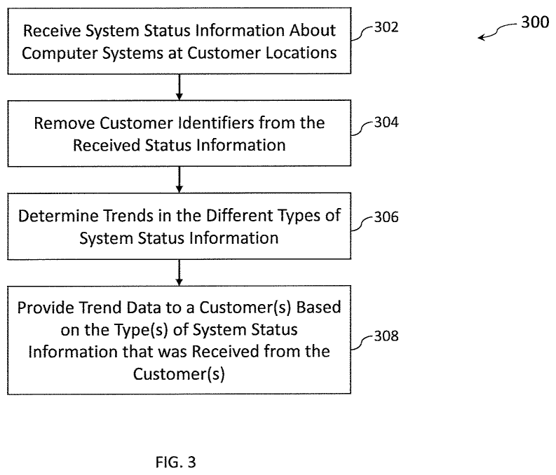

Turning now to FIG. 3, a flow diagram 300 of a process for sharing computer system information is generally shown in accordance with one or more embodiments of the present invention. All or a portion of the processing shown in FIG. 3 can be performed by the analysis engine 102 of FIG. 1. At block 302, system status information about computer systems belong to different customers is received. The system status information can be formatted as records and can include data of different types. Example types of system status information can include, but are not limited to: system configuration; system workload; throughput; system environmental characteristics; system update; known failure; and down time. At block 304, customer identifiers are removed from the received system status information.

At block 306 of FIG. 3, trends are determined in the different types of system status information, and at block 308 the trends are provided to a customer based on the types of system status information that was received from the customer. The trends can include, but are not limited to: averages; ranges; and percentages. In an embodiment of the present invention the trends are determined once for all of the customers, and then sent to the individual customers based on the data that they provided and the data that they are interested in (e.g., as described by the monitor filter). In another embodiment of the present invention, the trends are determined individually for each customer based on the data that they are interested in. A combination of approaches can be used based at least in part on the granularity of the monitor filter and how many other customers are interested in the same data. For example, there may only be a few customers who are interested in the temperature trend of a particular type of memory device so that trend may be calculated individually for each customer requesting the data. In another example, almost all customers may be interested in the temperature trend of an enterprise system so that trend may be calculated once and shared with all of the customers requesting that data.

In one or more embodiments of the present invention, the trend is compared to the system status information received from the customer and a recommendation is provided to the customer based on the comparison. As an example, one or more customers may want to watch software or hardware update trends.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

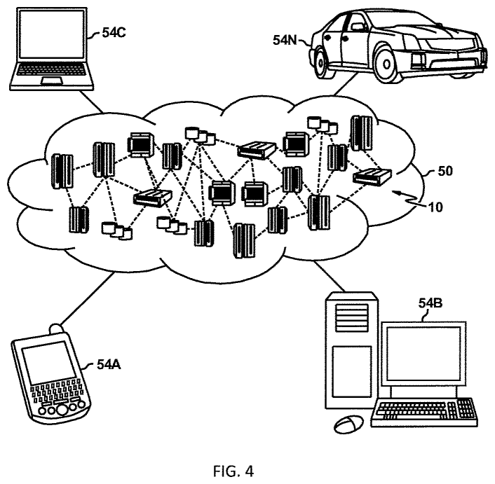

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

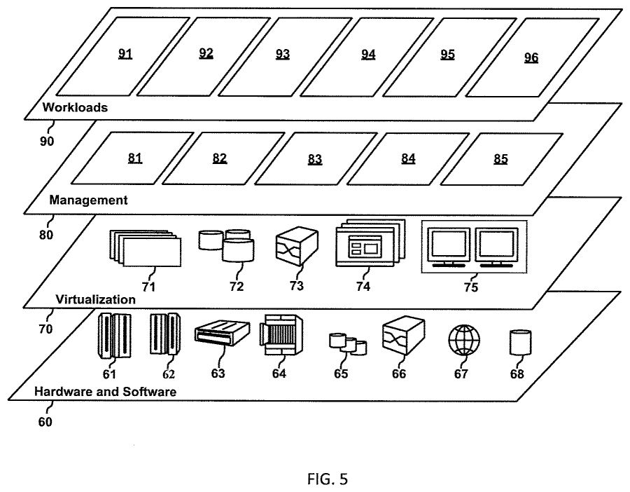

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

In accordance with one or more embodiments of the present invention, the system 100 shown in FIG. 1 is located in the cloud computing environment of FIG. 5 where all or a subset of the processing shown in FIGS. 2-3 is performed.

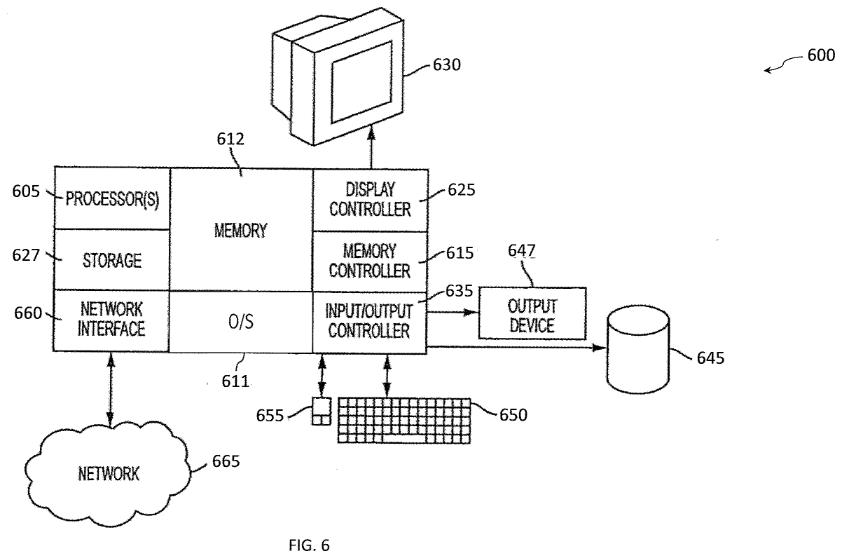

Turning now to FIG. 6, a block diagram of a computer system for implementing some or all aspects of sharing information for enterprise computers is generally shown in accordance with one or more embodiments of the present invention. The processing described herein may be implemented in hardware, software (e.g., firmware), or a combination thereof. In an exemplary embodiment, the methods described may be implemented, at least in part, in hardware and may be part of the microprocessor of a special or general-purpose computer system, such as a mobile device, personal computer, workstation, minicomputer, or mainframe computer. In an embodiment the analysis engine 102 of FIG. 1, the monitor module 110 of FIG. 1, and/or the collection module 108 of FIG. 1 are executed by the computer system shown in FIG. 6.

In an exemplary embodiment, as shown in FIG. 6, the computer system includes a processor 605, memory 612 coupled to a memory controller 615, and one or more input devices 645 and/or output devices 647, such as peripherals, that are communicatively coupled via a local I/O controller 635. These devices 647 and 645 may include, for example, a printer, a scanner, a microphone, and the like. A conventional keyboard 650 and mouse 655 may be coupled to the I/O controller 635. The I/O controller 635 may be, for example, one or more buses or other wired or wireless connections, as are known in the art. The I/O controller 635 may have additional elements, which are omitted for simplicity, such as controllers, buffers (caches), drivers, repeaters, and receivers, to enable communications.

The I/O devices 647, 645 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 605 is a hardware device for executing hardware instructions or software, particularly those stored in memory 612. The processor 605 may be a custom made or commercially available processor, a central processing unit (CPU), an auxiliary processor among several processors associated with the computer system, a semiconductor based microprocessor (in the form of a microchip or chip set), a microprocessor, or other device for executing instructions. The processor 605 can include a cache such as, but not limited to, an instruction cache to speed up executable instruction fetch, a data cache to speed up data fetch and store, and a translation look-aside buffer (TLB) used to speed up virtual-to-physical address translation for both executable instructions and data. The cache may be organized as a hierarchy of more cache levels (L, L2, etc.).

The memory 612 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 612 may incorporate electronic, magnetic, optical, or other types of storage media. Note that the memory 612 may have a distributed architecture, where various components are situated remote from one another but may be accessed by the processor 605.

The instructions in memory 612 may include one or more separate programs, each of which comprises an ordered listing of executable instructions for implementing logical functions. In the example of FIG. 6, the instructions in the memory 612 include a suitable operating system (OS) 611. The operating system 611 essentially may control the execution of other computer programs and provides scheduling, input-output control, file and data management, memory management, and communication control and related services.

Additional data, including, for example, instructions for the processor 605 or other retrievable information, may be stored in storage 627, which may be a storage device such as a hard disk drive or solid state drive. The stored instructions in memory 612 or in storage 627 may include those enabling the processor to execute one or more aspects of the dispatch systems and methods of this disclosure.

The computer system may further include a display controller 625 coupled to a display 630. In an exemplary embodiment, the computer system may further include a network interface 660 for coupling to a network 665. The network 665 may be an IP-based network for communication between the computer system and an external server, client and the like via a broadband connection. The network 665 transmits and receives data between the computer system and external systems. In an exemplary embodiment, the network 665 may be a managed IP network administered by a service provider. The network 665 may be implemented in a wireless fashion, e.g., using wireless protocols and technologies, such as WiFi, WiMax, etc. The network 665 may also be a packet-switched network such as a local area network, wide area network, metropolitan area network, the Internet, or other similar type of network environment. The network 665 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods for sharing information between computer systems can be embodied, in whole or in part, in computer program products or in computer systems, such as that illustrated in FIG. 6.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving system status information about a plurality of computer systems of a plurality of customers, the system status information comprising a plurality of types of system status information, each of the plurality of customers providing at least a subset of the plurality of types of system status information;
removing customer identifiers from the received system status information; and
performing for a customer of the plurality of customers:
determining whether a type of the plurality of types of system status information was received from the customer; and
based at least in part in determining that the type of system status information was received from the customer:
determining a trend in the type of system status information that was received from the customer, the trend determined based at least in part on system status information received from at least one other of the plurality of customers; and
providing the trend to the customer.

2. The method of claim 1, wherein the performing further comprises comparing the trend to the system status information received from the customer and providing a recommendation to the customer based at least in part on the comparing.

3. The method of claim 1, wherein the performing is based at least in part on receiving a request from the customer for the trend related to the type of system status information.

4. The method of claim 1, wherein the performing is performed automatically on a periodic basis for each of the plurality of customers.

5. The method of claim 1, wherein the performing is performed for each of the plurality of types of system status information.

6. The method of claim 1, wherein the plurality of types of system status information comprises two selected from the group consisting of: system configuration, system workload, system throughput, system environmental characteristics, system update, system known failure, and system down time.

7. The method of claim 1, wherein the trend comprises one selected from the group consisting of: an average, a range, a minimum, a maximum, and a percentage.

8. A system comprising:
a memory having computer readable instructions; and
one or more processors for executing the computer readable instructions, the computer readable instructions controlling the one or more processors to perform operations comprising:
receiving system status information about a plurality of computer systems of a plurality of customers, the system status information comprising a plurality of types of system status information, each of the plurality of customers providing at least a subset of the plurality of types of system status information;
removing customer identifiers from the received system status information; and
performing for a customer of the plurality of customers:
determining whether a type of the plurality of types of system status information was received from the customer; and
based at least in part in determining that the type of system status information was received from the customer:
determining a trend in the type of system status information that was received from the customer, the trend determined based at least in part on system status information received from at least one other of the plurality of customers; and
providing the trend to the customer.

9. The system of claim 8, wherein the performing further comprises comparing the trend to the system status information received from the customer and providing a recommendation to the customer based at least in part on the comparing.

10. The system of claim 8, wherein the performing is based at least in part on receiving a request from the customer for the trend related to the type of system status information.

11. The system of claim 8, wherein the performing is performed automatically on a periodic basis for each of the plurality of customers.

12. The system of claim 8, wherein the performing is performed for each of the plurality of types of system status information.

13. The system of claim 8, wherein the plurality of types of system status information comprises two selected from the group consisting of: system configuration, system workload, system throughput, system environmental characteristics, system update, system known failure, and system down time.

14. The system of claim 8, wherein the trend comprises one selected from the group consisting of: an average, a range, a minimum, a maximum, and a percentage.

15. A computer program product comprising a computer readable storage medium having program instructions embodied therewith, the program instructions executable by a processor to cause the processor to perform operations comprising:
receiving system status information about a plurality of computer systems of a plurality of customers, the system status information comprising a plurality of types of system status information, each of the plurality of customers providing at least a subset of the plurality of types of system status information;
removing customer identifiers from the received system status information; and
performing for a customer of the plurality of customers:
determining whether a type of the plurality of types of system status information was received from the customer; and
based at least in part in determining that the type of system status information was received from the customer:
determining a trend in the type of system status information that was received from the customer, the trend determined based at least in part on system status information received from at least one other of the plurality of customers; and
providing the trend to the customer.

16. The computer program product of claim 15, wherein the performing further comprises comparing the trend to the system status information received from the customer and providing a recommendation to the customer based at least in part on the comparing.

17. The computer program product of claim 15, wherein the performing is based at least in part on receiving a request from the customer for the trend related to the type of system status information.

18. The computer program product of claim 15, wherein the performing is performed automatically on a periodic basis for each of the plurality of customers.

19. The computer program product of claim 15, wherein the performing is performed for each of the plurality of types of system status information.

20. The computer program product of claim 15, wherein the plurality of types of system status information comprises two selected from the group consisting of: system configuration, system workload, system throughput, system environmental characteristics, system update, system known failure, and system down time.
